(19) United States
(12) Patent Application Publication
(10) Pub. No.: US 2026/0295542 A1
(43) Pub. Date: Oct. 1, 2026

(54) METHOD FOR PRODUCING DISPERSION COMPOSITION

(71) Applicants: artience Co., Ltd., Tokyo (JP); TOYOCOLOR CO., LTD., Tokyo (JP)

(72) Inventors: Hideaki TAKAI, Tokyo (JP); Kazuhiko TSUBOYA, Tokyo (JP); Satoru AIZAWA, Tokyo (JP)

(73) Assignees: artience Co., Ltd., Tokyo (JP); TOYOCOLOR CO., LTD., Tokyo (JP)

(21) Appl. No.: 19/477,113

(22) PCT Filed: Jun. 12, 2024
(86) PCT No.: PCT/JP2024/021314

§ 371 Date: Oct. 21, 2025

(30) Foreign Application Priority Data
Jun. 14, 2023 (JP) 2023-097975

(51) Int. Cl. B01F 23/50; B01F 25/452

(52) U.S. Cl. CPC B01F 23/51; B01F 23/56; B01F 25/45211; B01F 2215/0495

(57) ABSTRACT

The present invention improves the life of a sealing mechanism in dispersion treatment of a raw material composition comprising a dispersion medium and a dispersed phase, thereby improving the efficiency of the production of a dispersion composition. Provided is a method for producing a dispersion composition using a dispersion apparatus comprising: a dispersion mechanism which pressurizes and disperses a raw material composition; a supply mechanism which is equipped with a plunger part and supplies the raw material composition to the dispersion mechanism; and a sealing mechanism which seals the plunger part with a sealing liquid medium. The raw material composition comprises a dispersed phase and a dispersion medium, and the sealing liquid medium at least includes the same dispersed phase as that of the raw material composition and the same dispersion medium as that of the raw material composition.

### TECHNICAL FIELD

The present invention relates to a method for producing a dispersion composition.

### BACKGROUND ART

Methods for dispersing a dispersed phase in a dispersion medium include stirrers, ball mill dispersers, bead mill dispersers, ultrasonic dispersers, single-screw kneaders, multi-screw kneaders, roll mill dispersers, high pressure homogenizers, etc. From the viewpoint of dispersion efficiency, bead mill dispersers are widely used, but while bead mills have the advantage of applying impact to the dispersed phase to finely disperse the dispersed phase, the impact may damage the dispersed phase, and reduce the inherent characteristics of the dispersed phase. High pressure homogenizers can uniformly disperse a treatment liquid by a method of discharging the treatment liquid from a nozzle, or a method of passing the treatment liquid through a homogenizing valve. Since the treatment liquid is supplied at high pressure to enhance dispersion efficiency, the dispersed phase can be finely dispersed by the shear force and collision between treatment liquids, collision with the wall surface of the homogenizing valve, etc.

Valve-type high pressure homogenizers can increase the flow rate of the treatment liquid, and are suitable for mass production for such high pressure homogenizers do not require nozzles that may cause clogging, and are used as the aqueous homogenizing apparatuses for dairy products, beverages, etc. Since dairy products or the like have little solid content and are aqueous, dairy products have a small effect on the members of the dispersion apparatuses, and have the advantage that, for example, deterioration of packing, etc. of high pressure pumps is slow and the replacement period is long.

In recent years, high pressure homogenizers are also used as the dispersion apparatuses for various dispersion compositions such as inks. In inks or the like, various dispersed phases and liquid media are used. Raw material compositions containing solid content tend to act on packing, etc. of high pressure pumps, and deterioration of the packing shortens the replacement period of the packing, which may reduce work efficiency. Furthermore, there is also a problem that liquid leakage of the raw material composition from the high pressure pumps increases due to deterioration of the packing.

Patent Document 1 proposes a method in which a coarse dispersion liquid containing carbon nanotubes and a solvent is stored in a tank, and the coarse dispersion liquid is sent to a disperser by a high pressure pump for dispersion treatment. In the method, the high-temperature carbon nanotube dispersion liquid discharged from the disperser is cooled to prevent bubbles from being generated in the dispersion liquid, and the back pressure of the dispersion liquid is reduced in multiple stages to prevent bubbles from being generated in the dispersion liquid during release to atmospheric pressure, thereby enhancing the dispersibility of the carbon nanotubes.

### RELATED ART DOCUMENTS

### Patent Documents

Patent Document 1: International Publication No. 2015/015758
Patent Document 2: Japanese Patent Application Laid-Open No. 2018-511018

### SUMMARY OF INVENTION

### Problem to be Solved by the Invention

In the conventional technology as disclosed in Patent Document 1, a plunger is used in the high pressure pump to supply the raw material composition to the dispersion mechanism at high pressure. Since the plunger is installed inside a cylinder, gland packing has been disposed in the gap between the plunger and the cylinder in the conventional technology. However, as described above, gland packing deteriorates through repeated use and therefore requires replacement work, and the possibility of liquid leakage due to deterioration of the gland packing cannot be completely eliminated. Particularly, in the case of the raw material composition containing a dispersed phase and a dispersion medium, there is a tendency that the solid content is likely to cause deterioration of the gland packing. Therefore, there is an increasing demand for new technology that can solve the problem of gland packing deterioration in raw material compositions containing solid content. Although the sealing device disclosed in Patent Document 2 does not use gland packing, there is no conventional knowledge of using this in a method for producing a dispersion composition containing solid content.

One objective of the present invention is to improve the life of a sealing mechanism in dispersion treatment of a raw material composition including a dispersion medium and a dispersed phase, and to improve the productivity of a dispersion composition.

### Means for Solving the Problem

As a result of intensive studies for the purpose of solving the above problem, the inventors of the present invention have found that, by using a sealing liquid medium as the sealing mechanism for the plunger part, the plunger part can be sealed without using gland packing as the sealing mechanism for the plunger part. This fundamentally solves the problem of gland packing deterioration, extends the life of the sealing mechanism for the plunger part, and enables long-term operation. Furthermore, by including at least the same dispersed phase as the raw material composition and the same dispersion medium as the raw material composition in the sealing liquid medium, deterioration of the quality of the dispersion composition can be suppressed.

That is, the present invention includes the following embodiments. The embodiments of the present invention are not limited to the following.

<1> A method for producing a dispersion composition using a dispersion apparatus, which includes a dispersion mechanism that pressurizes and disperses a raw material composition, a supply mechanism that includes a plunger part and supplies the raw material composition to the dispersion mechanism, and a sealing mechanism that seals the plunger part using a sealing liquid medium, in which the raw material composition includes a dispersed phase and a dispersion medium, and the sealing liquid medium includes at least the same dispersed phase as the raw material composition and the same dispersion medium as the raw material composition.

<2> The method for producing a dispersion composition according to <1>, in which the sealing liquid medium is pressurized using an independent pump and supplied to the sealing mechanism.

<3> The method for producing a dispersion composition according to <1> or <2>, in which the sealing liquid medium has a particle diameter D50 of 5 μm or less at volume-based cumulative 50% of a particle size distribution measured by a dynamic light scattering method.

<4> The method for producing a dispersion composition according to any one of <1> to <3>, in which the sealing liquid medium has a viscosity of 10000 mPa·s or less at 25° C.

### Effects of the Invention

According to an embodiment of the present invention, it is possible to improve the life of a sealing mechanism in dispersion treatment of a raw material composition including a dispersion medium and a dispersed phase, and to improve the productivity of a dispersion composition.

### BRIEF DESCRIPTION OF THE DRAWINGS

FIG. 1 is a schematic view showing an example of the dispersion apparatus.

FIG. 2 is a cross-sectional view schematically showing the high pressure pump and the sealing mechanism of an example of the dispersion apparatus.

FIG. 3 is a cross-sectional view schematically showing the homogenizing valve of the dispersion part of an example of the dispersion apparatus.

### DESCRIPTION OF THE EMBODIMENTS

Hereinafter, a method for producing a dispersion composition according to an embodiment of the present invention will be described in detail. The present invention is not limited to the following embodiments, and the present invention also includes embodiments implemented within a range that does not change the gist of the present invention.

### <Dispersion Apparatus>

Hereinafter, a method for producing a dispersion composition including a dispersed phase and a dispersion medium using a dispersion apparatus will be described. The dispersion composition may further include a dispersant. The dispersion composition can be produced using a dispersion apparatus, which includes a dispersion mechanism that pressurizes and disperses a raw material composition, a supply mechanism that includes a plunger part and supplies the raw material composition to the dispersion mechanism, and a sealing mechanism that seals the plunger part using a sealing liquid medium. The raw material composition is a composition in which raw materials of the dispersion composition are mixed and included. The raw material composition may be a composition in a mixed state, or may be a composition in a coarsely dispersed state after mixing.

A high pressure homogenizer can be mentioned as an example of such a dispersion apparatus. The high pressure homogenizer can supply the raw material composition at high pressure from a high pressure pump to a dispersion part by reciprocating movement of a plunger, and can perform dispersion treatment on the raw material composition in the dispersion part. In an example of the dispersion part, the raw material composition can be jetted at high pressure from a minute opening at the tip of a nozzle, and the dispersed phase can be dispersed in the dispersion medium by the collision and shear force between the raw material compositions. In another example of the dispersion part, the raw material composition can be supplied at high pressure to a homogenizing valve, and the dispersed phase can be dispersed in the dispersion medium by causing the raw material composition to collide with the wall surface of the homogenizing valve to apply impact. The method of performing dispersion treatment using a homogenizing valve can increase the flow rate of the raw material composition, and can avoid problems such as nozzle clogging, which is suitable for mass production.

The pressure of the raw material composition in the case of being supplied to the dispersion part is preferably 10 MPa to 150 MPa. In the case of the dispersion part being a nozzle type, the pressure of the raw material composition at the time of being supplied to the dispersion part is preferably 60 MPa to 150 MPa in a normal range. In the case of the disperser being a valve type, the pressure of the raw material composition at the time of being supplied to the disperser is preferably 10 MPa to 150 MPa in a normal range.

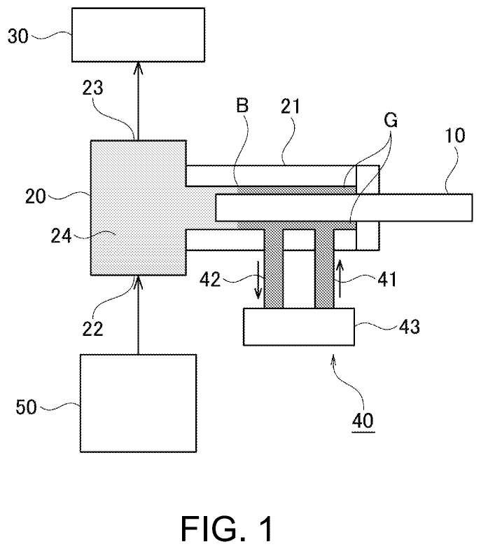

FIG. 1 shows a schematic view of an example of the dispersion apparatus. The dispersion apparatus 100 includes a high pressure pump 20 that is a form of the supply mechanism, a dispersion part 30 that is a form of the dispersion mechanism, and a sealing mechanism 40. The high pressure pump 20 includes a plunger 10. A raw material composition tank 50 is a container in which the raw material composition to be supplied to the high pressure pump 20 is stored.

The high pressure pump 20 includes a supply port 22 to which the raw material composition is supplied from the raw material composition tank 50, and a discharge port 23 from which the raw material composition is discharged to the dispersion part 30. The high pressure pump 20 includes a cylinder 21 that supports the plunger 10 to be capable of performing reciprocating movement in the axial direction. The cylinder 21 is provided with the sealing mechanism 40 so that the raw material composition and pressure do not leak from the high pressure pump 20 to the outside.

The plunger 10 has one end inserted into the high pressure pump 20 and the other end extending to the outside of the high pressure pump 20, and is supported by the cylinder 21. The sliding surface between the plunger 10 and the cylinder 21 is preferably sealed in a slidable manner to prevent liquid leakage of the raw material composition from the high pressure pump 20, and it is further preferable that pressure loss does not occur due to air outflow from the high pressure pump 20 to the outside. The plunger 10 performs reciprocating movement in the axial direction, whereby the volume of the pressure chamber of the high pressure pump 20 changes. In the case of the plunger 10 being pulled out from the high pressure pump 20 and the volume of the pressure chamber increasing, the raw material composition is sucked from the supply port 22 of the high pressure pump 20. In the case of the plunger 10 being pushed into the high pressure pump 20 and the volume of the pressure chamber decreasing, the raw material composition is discharged from the discharge port 23 of the high pressure pump 20. Preferably, the supply port 22 and the discharge port 23 of the high pressure pump 20 are respectively provided with valves to prevent backflow of the raw material composition.

The raw material composition discharged from the high pressure pump 20 is supplied to the dispersion part 30 at high pressure. The dispersion part 30 may be a nozzle type or a valve type. Since it is possible to supply a large amount of raw material composition to the dispersion part 30 at high pressure using the plunger 10, the dispersion part 30 is preferably a valve type, and specifically a homogenizing valve is preferable. After dispersion treatment, a dispersion composition in which the dispersed phase is dispersed in the dispersion medium is obtained. Although not shown, the dispersion composition subjected to dispersion treatment can be recovered in a dispersion composition tank from the discharge port of the dispersion part 30 through piping.

The sealing mechanism 40 includes a sealing liquid medium supply pipe 41, a sealing liquid medium discharge pipe 42, and a storage part 43 that supplies a sealing liquid medium to the sealing liquid medium supply pipe 41 and recovers the sealing liquid medium from the sealing liquid medium discharge pipe 42.

The sealing liquid medium supplied from the sealing mechanism 40 into the cylinder 21 is filled in a gap G between the outer peripheral surface of the plunger 10 and the inner peripheral surface of the cylinder 21, and can seal this gap G. To enhance the sealing performance, preferably this gap G is tightly filled with the raw material composition and/or the sealing liquid medium.

The gap G is preferably formed over the entire circumference of the outer peripheral surface of the plunger 10. By preventing direct contact between the plunger 10 and the cylinder 21, pressure load can be reduced. Moreover, by supporting the outer peripheral surface of the plunger 10 over the entire circumference with the pressurized liquid medium, axial deviation of the reciprocating movement of the plunger 10 can be reduced. From such a viewpoint, the liquid medium in contact with the outer peripheral surface of the plunger 10 may be the sealing liquid medium, or may be the raw material composition indirectly pressurized by the sealing liquid medium.

The raw material composition supplied to a pump chamber 24 and the sealing liquid medium supplied to the gap G come into contact with each other at the interface thereof. In this case, a boundary portion B between the raw material composition and the sealing liquid medium may form an interface without mixing with each other, or may mix with each other to show a concentration gradient. Preferably, the boundary portion B is formed in the gap G between the outer peripheral surface of the plunger 10 and the inner peripheral surface of the cylinder 21. It is preferable to adjust the respective supply pressures for the sealing liquid medium and the raw material composition so that the boundary portion B is not formed on the pump chamber 24 side relative to the tip portion of the plunger 10 within the range of the reciprocating movement amount of the plunger 10 in the axial direction of the plunger 10.

According to an embodiment, the solid content concentration, etc. does not fluctuate significantly in the obtained dispersion composition even in the case of the sealing liquid medium being mixed into the raw material composition, but it is preferable to prevent a large amount of sealing liquid medium from being discharged into the pump chamber 24.

In the illustrated example, the sealing liquid medium is supplied from the storage part 43 and recovered to the storage part 43. The sealing liquid medium recovered to the storage part 43 may be reused and recirculated. In another example, the sealing liquid medium discharged from the sealing liquid medium discharge pipe 42 may be discarded.

In the illustrated example, the sealing liquid medium discharge pipe 42 is disposed on the pump chamber 24 side in the axial direction of the plunger 10, and the sealing liquid medium supply pipe 41 is disposed on the opposite side. In this example, the composition of the sealing liquid medium is maintained in the region on the side opposite to the pump chamber 24 in the axial direction of the plunger 10, and along with movement in the direction toward the pump chamber 24, the sealing liquid medium and the raw material composition may mix, potentially changing the composition of the sealing liquid medium. Then, by discharging the sealing liquid medium at a point where the concentration gradient of the sealing liquid medium composition reaches a certain concentration level, an increase in the amount of sealing liquid medium mixed into the raw material composition can be suppressed. The supply position and discharge position of the sealing liquid medium to the cylinder 21 are not limited to the illustrated examples and can be modified. For example, in addition to these modifications, the allowable range of the amount of sealing liquid medium mixed into the pump chamber 24, the compositional identity between the raw material composition and the sealing liquid medium, etc. may be adjusted.

In the illustrated example, the end portion on the apparatus outer side in the axial direction of the plunger 10 is provided with an outer sleeve 25 that covers the opening of the cylinder 21. Since the sealing performance of the raw material composition is ensured by the sealing mechanism 40 within the cylinder 21, the opening of the cylinder 21 may remain in an open state, but providing the outer sleeve 25 can further suppress liquid leakage.

The sealing liquid medium may be pressurized using an independent pump and supplied to the sealing mechanism. For example, although not shown, a pump may be provided in the path of the sealing liquid medium supply pipe 41, enabling supply of the high-pressure sealing liquid medium into the cylinder 21. A shear force is applied to the sealing liquid medium through pressurization of this pump, thereby maintaining favorable dispersibility of the dispersed phase in the sealing liquid medium. Then, in the case of the sealing liquid medium mixing with the raw material composition, the possibility of causing aggregation of the dispersed phase can be further reduced.

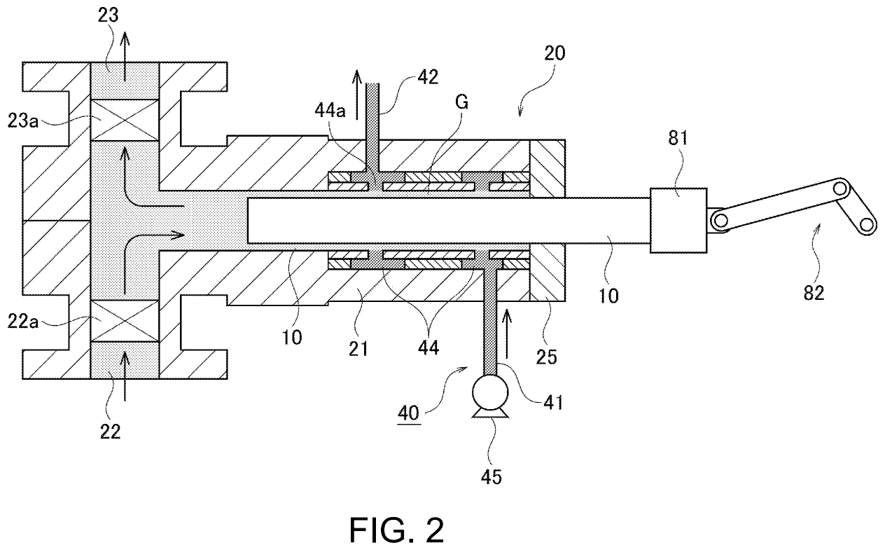

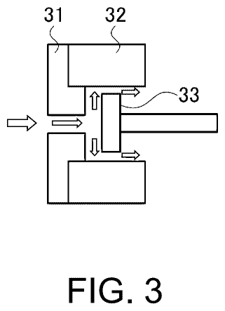

A specific example of the dispersion apparatus is described using FIG. 2 and FIG. 3. Members common to FIG. 1 are assigned with the same reference numerals, and parts with no particular explanation are as described in FIG. 1 above. In FIG. 2, the high pressure pump 20 includes a check valve 22a and a check valve 23a respectively at the supply port 22 and the discharge port 23. On the inner peripheral surface of the cylinder 21, a chamber 44 is densely filled with the sealing liquid medium by the sealing mechanism 40. The plunger 10 is provided inside the cylinder 21. The end portion on the outer side of the high pressure pump 20 in the axial direction of the plunger 10 includes a mechanism in which reciprocating movement is transmitted via a rod 81 by a crankshaft 82, and the plunger 10 is capable of reciprocating movement in the axial direction.

The sealing mechanism 40 includes the sealing liquid medium supply pipe 41, the sealing liquid medium discharge pipe 42, and a pump 45 capable of supplying the sealing liquid medium to the sealing liquid medium supply pipe 41 at high pressure. Although not shown, a tank may be provided for storing the sealing liquid medium supplied to the pump 45. Although not shown, a mechanism may be provided for recovering the sealing liquid medium discharged from the sealing liquid medium discharge pipe 42 into this tank and recirculating the sealing liquid medium.

In FIG. 2, the sealing mechanism 40 includes the chamber 44 that holds the sealing liquid medium on the inner peripheral surface of the cylinder 21. Then, the gap G is formed between the inner peripheral surface of the cylinder 21 and the outer peripheral surface of the plunger 10. The raw material composition is supplied from the pump chamber 24 to this gap G and filled therein. The pressure between the gap G and the chamber 44 is released through a through opening 44a. In a pressure environment, the raw material composition in the gap G is at positive pressure relative to the sealing liquid medium in the chamber 44. This can prevent the sealing liquid medium from flowing into the dispersion part from the gap G. Additionally, in the gap G, the raw material composition is densely filled on the outer peripheral surface of the plunger 10 by pressurization from the sealing liquid medium in the chamber 44, thereby enhancing sealing performance.

In supplying the sealing liquid medium into the chamber 44 by the pump 45, the external pressure within the chamber 44 can be adjusted by adjusting the output of the pump 45. Additionally, the internal pressure of the raw material composition can be adjusted by adjusting the output of the plunger 10. Although not limited to the illustrated example, in the case of the external pressure being 50 bar to 5000 bar, the internal pressure is preferably 80 bar to 8000 bar, and more preferably, in the case of the external pressure being 300 bar to 1000 bar, the internal pressure is 400 bar to 1500 bar.

The chamber 44 is preferably formed over the entire circumference in the circumferential direction of the cylinder 21. The chamber 44 may be provided at one location or two or more locations in the axial direction of the cylinder 21. In the illustrated example, two chambers 44 are arranged at two locations in the axial direction of the cylinder 21 with a partition wall therebetween. This can make the sealing performance in the gap G more uniform within the movement range of the plunger 10 in the axial direction. Additionally, in the illustrated example, the contact area between the raw material composition and the sealing liquid medium can be reduced, so mixing of both liquid media with each other can be further suppressed, and variation in solid content in the obtained dispersion composition can be further reduced.

The chambers 44 at multiple locations may be in communication with each other and have the sealing liquid medium supplied and discharged using a pair of sealing liquid medium supply pipe 41 and sealing liquid medium discharge pipe 42. Alternatively, the chambers 44 at multiple locations may be isolated from each other and each chamber may be provided with a pair of sealing liquid medium supply pipe 41 and sealing liquid medium discharge pipe 42.

In another example, the chamber 44 may be arranged over a wide range in the movement range of the plunger 10 in the axial direction, and through openings may be provided at one location or two or more locations in the axial direction of the plunger 10 per chamber 44.

Multiple through openings 44a may be provided isolated from each other in the circumferential direction of the chamber 44. In another example, the through openings 44a may be provided in communication over the entire circumference in the circumferential direction of the chamber 44.

FIG. 3 is a cross-sectional view schematically showing the homogenizing valve of the dispersion part 30. In FIG. 3, the homogenizing valve of the dispersion part 30 includes a valve seat 31, an impact ring 32, and a homo valve 33. The raw material composition supplied from the high pressure pump 20 is supplied to the homogenizing valve at high pressure in the arrow direction in the figure and subjected to fine dispersion treatment, and then is discharged from a discharge port (not shown).

As valve-type high pressure homogenizers that are examples of the dispersion apparatus, “HC3 Series” manufactured by Sanmaru Machinery Co., Ltd., “HV-H Series” manufactured by Izumi Food Machinery, “R-Model” manufactured by SPX Flow, etc. can be used. As another example of the dispersion apparatus, nozzle-type high pressure homogenizers can be used. As nozzle-type high pressure homogenizers, “Genus PY” manufactured by Genus, “Starburst” manufactured by Sugino Machine, “Nanomizer” manufactured by Nanomizer, etc. can be used, but are not limited thereto. A nozzle-type high pressure homogenizer includes a pump and one or more nozzles, and there are various nozzle shapes for performing dispersion treatment. For example, there are types that cause high-pressure collision between raw materials, types that cause high-pressure raw materials to collide with ceramic balls or pass through slits and process by shear force, types that utilize cavitation by jets of high-pressure raw materials, etc., but are not limited thereto. In these commercially available dispersion apparatuses, the sealing mechanism between the plunger and the cylinder can be changed to the sealing mechanism described above for use.

### <Raw Material Composition>

The raw material composition supplied to the dispersion apparatus is not particularly limited as long as the raw material composition includes a dispersed phase and a dispersion medium. The raw material composition may further include a dispersant to obtain dispersion stability of the dispersed phase. The raw material composition may include optional components such as resin emulsion, surfactant, binder resin, wetting agent, wetting penetrant, and leveling agent as required.

The dispersed phase may be inorganic particles, organic particles, inorganic-organic composite particles, and the like, or combinations thereof, and particles that can be dispersed in the dispersion medium are preferable, and particles that show insolubility in the dispersion medium are preferable. Examples of inorganic particles include carbon materials, ceramics, metal, etc. Examples of carbon materials include carbon black, carbon nanotube, fullerene, graphene, multi-walled graphene, graphite, etc. Examples of carbon black include acetylene black, furnace black, hollow carbon black, Ketjen black, etc. These carbon materials may be neutral, acidic, or basic, and may be subjected to oxidation treatment or graphitization treatment. Examples of ceramics include metal oxides, carbonates, nitrides, phosphates, carbides, etc., such as calcium oxide, calcium carbonate, magnesium oxide, magnesium carbonate, magnesium phosphate, aluminum oxide, aluminum nitride, aluminum phosphate, boron nitride, silicon oxide, silicon nitride, silicon carbide, zirconium oxide, titanium oxide, and kaolin clay. Examples of metals include zinc, lead, titanium, cadmium, iron, copper, cobalt, or alloys thereof.

As organic particles, resin particles are preferable, and examples include polystyrene, polyurethane, polyester, polyamide, vinyl-based polymers, acrylic-based polymers, composite polymers thereof; and cellulose, pulp fibers, etc.

Organic pigments or inorganic pigments may be used as the dispersed phase. Examples of organic pigments include azo-based, phthalocyanine-based, anthraquinone-based, perylene-based, perinone-based, quinacridone-based, thioindigo-based, dioxazine-based, isoindolinone-based, quinophthalone-based, azomethine azo-based, diketopyrrolopyrrole-based, and isoindoline-based pigments. More specifically, examples include Carmine 6B, Lake Red C, Permanent Red 2B, Disazo Yellow, Pyrazolone Orange, Carmine FB, Chromophthal Yellow, Chromophthal Red, Phthalocyanine Blue, Phthalocyanine Green, Dioxazine Violet, Quinacridone Magenta, Quinacridone Red, Indanthrene Blue, Pyrimidine Yellow, Thioindigo Bordeaux, Thioindigo Magenta, Perylene Red, Perinone Orange, Isoindolinone Yellow, Diketopyrrolopyrrole Red, Aniline Black, and daylight fluorescent pigments. Furthermore, as organic pigments, among the colorants described in the Colour Index International (abbreviated as C.I.), examples include C.I. Pigment Black, C.I. Pigment Blue, C.I. Pigment Green, C.I. Pigment Red, C.I. Pigment Violet, C.I. Pigment Yellow, C.I. Pigment Orange, C.I. Pigment Brown, etc., which are organic compounds or organometallic complexes.

Examples of inorganic pigments include white pigments such as titanium oxide, zinc oxide, zinc sulfide, barium sulfate, calcium carbonate, chromium oxide, and silica; non-white pigments such as aluminum powder, mica, bronze powder, chrome vermillion, yellow lead, cadmium yellow, cadmium red, aluminum hydroxide, ultramarine, prussian blue, red iron oxide, yellow iron oxide, iron black, titanium oxide, and zinc oxide.

The above-described dispersed phase may be surface-treated. The above-described dispersed phase may be used alone or in combination of two or more types. The content of the dispersed phase in the raw material composition is not particularly limited and may be appropriately adjusted within a range where the dispersed phase can be dispersed in the dispersion medium after dispersion treatment, according to the materials of the dispersed phase and the dispersion medium.

As the dispersion medium, a dispersion medium capable of dispersing the dispersed phase may be used according to the type of dispersed phase. The dispersion medium may be a non-aqueous dispersion medium or an aqueous dispersion medium. The dispersion medium may include an organic solvent or water. The dispersion medium may include at least one of a water-insoluble organic solvent and a water-soluble organic solvent. In the case of combining water and an organic solvent, from the viewpoint of compatibility, the dispersion medium is preferably a combination of a water-soluble organic solvent and water. The dispersion medium may also be composed of water alone.

The organic solvent may be a non-polar solvent or a polar solvent, and these may be used in combination within a miscible range. Examples of non-polar solvents include aliphatic hydrocarbon solvents such as hexane, cyclohexane, and paraffin; aromatic hydrocarbon solvents such as benzene, toluene, and xylene; other petroleum-based hydrocarbon solvents, etc. Examples of polar solvents include ester-based solvents, ether-based solvents, alcohol-based solvents, ketone-based solvents, amide-based solvents, heterocyclic solvents, sulfoxide-based solvents, sulfone-based solvents, carbonate-based solvents, etc.

More specifically, examples of organic solvents include amide-based solvents (N-methyl-2-pyrrolidone (NMP), N-ethyl-2-pyrrolidone (NEP), N,N-dimethylformamide, N,N-dimethylacetamide, N,N-diethylacetamide, N-methylcaprolactam, and the like), heterocyclic solvents (cyclohexylpyrrolidone, 2-oxazolidone, 1,3-dimethyl-2-imidazolidinone, γ-butyrolactone, and the like), sulfoxide-based solvents (dimethyl sulfoxide and the like), sulfone-based solvents (hexamethylphosphorotriamide, sulfolane, and the like), lower ketone-based solvents (acetone, methyl ethyl ketone, and the like), carbonate-based solvents (diethyl carbonate, dimethyl carbonate, ethyl methyl carbonate, fluoroethylene carbonate, propylene carbonate, ethylene carbonate), tetrahydrofuran, acetonitrile, etc.

Furthermore, examples of organic solvents include formic acid, acetic acid, methanol, ethanol, propanol, methyl acetate, ethyl acetate, diethyl ether, etc. Moreover, examples of organic solvents include ethyl lactate, benzyl alcohol, 1,2,3-trichloropropane, 1,3-butanediol, 1,3-butylene glycol, 1,3-butylene glycol diacetate, 1,4-dioxane, 2-heptanone, 2-methyl-1,3-propanediol, 3,5,5-trimethyl-2-cyclohexen-1-one, 3,3,5-trimethylcyclohexanone, ethyl 3-ethoxypropionate, 3-methyl-1,3-butanediol, 3-methoxy-3-methyl-1-butanol, 3-methoxy-3-methylbutyl acetate, 3-methoxybutanol, 3-methoxybutyl acetate, 4-heptanone, m-xylene, m-diethylbenzene, m-dichlorobenzene, n-butyl alcohol, n-butylbenzene, n-propyl acetate, o-xylene, o-chlorotoluene, o-diethylbenzene, o-dichlorobenzene, p-chlorotoluene, p-diethylbenzene, sec-butylbenzene, tert-butylbenzene, isobutyl alcohol, isophorone, ethylene glycol diethyl ether, ethylene glycol dibutyl ether, ethylene glycol monoisopropyl ether, ethylene glycol monoethyl ether, ethylene glycol monoethyl ether acetate, ethylene glycol monotertiary butyl ether, ethylene glycol monobutyl ether, ethylene glycol monobutyl ether acetate, ethylene glycol monopropyl ether, ethylene glycol monohexyl ether, ethylene glycol monomethyl ether, ethylene glycol monomethyl ether acetate, diisobutyl ketone, diethylene glycol diethyl ether, diethylene glycol dimethyl ether, diethylene glycol monoisopropyl ether, diethylene glycol monoethyl ether acetate, diethylene glycol monobutyl ether, diethylene glycol monobutyl ether acetate, diethylene glycol monomethyl ether, cyclohexanol, cyclohexanol acetate, cyclohexanone, dipropylene glycol dimethyl ether, dipropylene glycol methyl ether acetate, dipropylene glycol monoethyl ether, dipropylene glycol monobutyl ether, dipropylene glycol monopropyl ether, dipropylene glycol monomethyl ether, diacetone alcohol, triacetin, tripropylene glycol monobutyl ether, tripropylene glycol monomethyl ether, propylene glycol diacetate, propylene glycol phenyl ether, propylene glycol monoethyl ether, propylene glycol monoethyl ether acetate, propylene glycol monobutyl ether, propylene glycol monopropyl ether, propylene glycol monomethyl ether, propylene glycol monomethyl ether acetate, propylene glycol monomethyl ether propionate, benzyl alcohol, methyl isobutyl ketone, methylcyclohexanol, n-amyl acetate, n-butyl acetate, isoamyl acetate, isobutyl acetate, propyl acetate, dibasic acid ester, etc. The dispersion medium may be used alone or in combination of two or more types.

The raw material composition may further include a dispersant. Both resin-type dispersants and surfactants can be used as the dispersant, but a suitable type of dispersant can be used in a suitable blending amount according to the characteristics required for dispersion of the dispersed phase.

As the resin-type dispersant, (meth)acrylic polymers, polymers derived from ethylenically unsaturated hydrocarbons, cellulose derivatives, copolymers thereof, etc. can be used. Examples of polymers derived from ethylenically unsaturated hydrocarbons include polyvinyl alcohol resins, polyvinylpyrrolidone resins, polyacrylonitrile resins, nitrile rubbers, etc. Examples of polyvinyl alcohol resins include polyvinyl alcohol, modified polyvinyl alcohol having functional groups other than hydroxyl groups (for example, acetyl groups, sulfo groups, carboxy groups, carbonyl groups, amino groups), polyvinyl alcohol modified with various salts, other anion-modified or cation-modified polyvinyl alcohol, polyvinyl acetal (polyvinyl acetoacetal, polyvinyl butyral, etc.) that has been acetal-modified (acetoacetal modification or butyral modification) with aldehydes, etc. The polyacrylonitrile resin may be a homopolymer of polyacrylonitrile, a copolymer of polyacrylonitrile, modified products thereof, etc., and polyacrylonitrile resins having at least one selected from the group consisting of active hydrogen groups such as hydroxyl groups, carboxy groups, primary amino groups, secondary amino groups, and mercapto groups, basic groups, alkyl groups introduced from (meth)acrylic acid alkyl esters or α-olefins are preferable. For example, the acrylonitrile copolymer described in Japanese Patent Application Laid-Open No. 2020-163362 can be used. Examples of nitrile rubbers include acrylonitrile butadiene rubber, hydrogenated acrylonitrile butadiene rubber, etc. Examples of cellulose derivatives include cellulose acetate, cellulose acetate butyrate, cellulose butyrate, cyanoethyl cellulose, ethyl hydroxyethyl cellulose, nitrocellulose, methyl cellulose, ethyl cellulose, hydroxyethyl cellulose, hydroxypropyl cellulose, hydroxypropyl methyl cellulose, carboxymethyl cellulose, and the like, or copolymers thereof. Additionally, dispersants described in International Publication No. 2008/108360, Japanese Patent Application Laid-Open No. 2018-192379, Japanese Patent Application Laid-Open No. 2019-087304, Japanese Patent No. 6524479, and Japanese Patent Application Laid-Open No. 2009-026744 may be used, but are not limited thereto. Particularly preferable are methyl cellulose, ethyl cellulose, polyvinyl alcohol, polyvinyl butyral, polyvinylpyrrolidone, homopolymers of polyacrylonitrile, copolymers of polyacrylonitrile, and hydrogenated acrylonitrile butadiene rubber. Polymers in which other substituents are introduced into part of these polymers, modified polymers, and the like may also be used. The surfactant may be any of anionic surfactants, cationic surfactants, zwitterionic surfactants, and nonionic surfactants. The dispersant is preferably 5 parts by mass to 300 parts by mass, more preferably 10 parts by mass to 200 parts by mass, and even more preferably 15 parts by mass to 100 parts by mass, relative to 100 parts by mass of the dispersed phase.

Relative to the total amount of the raw material composition, the content of the dispersed phase varies depending on the specific gravity of the dispersed phase, but is preferably 0.1% by mass to 80% by mass, more preferably 0.5% by mass to 60% by mass, and even more preferably 0.7% by mass to 50% by mass. The raw material composition preferably has a solid content amount of 0.5% by mass to 80% by mass, more preferably 0.7% by mass to 60% by mass, and even more preferably 1% by mass to 50% by mass.

### <Sealing Liquid Medium>

The sealing liquid medium includes at least the same dispersed phase as the raw material composition and the same dispersion medium as the raw material composition. For example, the sealing liquid medium may include at least a dispersed phase of the same simple substance or compound as the raw material composition and a dispersion medium of the same compound as the raw material composition. By using such a sealing liquid medium, in a dispersion apparatus with improved life of the sealing mechanism, it becomes possible to adjust the solid content to a desired range in the obtained dispersion composition.

The sealing liquid medium includes at least the same dispersed phase as the raw material composition. That is, at least one type of dispersed phase may be the same between the sealing liquid medium and the raw material composition. In the case of either the sealing liquid medium or the raw material composition including two or more types of dispersed phases, any one type of dispersed phase may be the same between the sealing liquid medium and the raw material composition. Preferably, the sealing liquid medium and the raw material composition each include one type of dispersed phase, and this dispersed phase is the same as each other. In the case of the sealing liquid medium and the raw material composition each including two or more types of dispersed phases, it is preferable that the two or more types of dispersed phases are the same as each other respectively.

The sealing liquid medium includes at least the same dispersion medium as the raw material composition. That is, at least one type of dispersion medium may be the same between the sealing liquid medium and the raw material composition. In the case of either the sealing liquid medium or the raw material composition including two or more types of dispersion media, any one type of dispersion medium may be the same between the sealing liquid medium and the raw material composition. Preferably, the sealing liquid medium and the raw material composition each include one type of dispersion medium, and this dispersion medium is the same as each other. In the case of the sealing liquid medium and the raw material composition each including two or more types of dispersion media, it is preferable that the two or more types of dispersion media are the same as each other respectively.

For example, at least one type of dispersed phase and at least one type of dispersion medium may be the same between the sealing liquid medium and the raw material composition. Preferably, the sealing liquid medium and the raw material composition each include one type of dispersed phase and one type of dispersion medium, and these are the same as each other between the sealing liquid medium and the raw material composition. Further, the sealing liquid medium and the raw material composition each include two or more types of dispersed phases and two or more types of dispersion media, and these are preferably the same as each other respectively between the sealing liquid medium and the raw material composition.

From the above viewpoint, the sealing liquid medium may include a single component dispersed phase or may include two or more types of dispersed phases. In the sealing liquid medium, the type of dispersed phase is not particularly limited, and one type or two or more types can be selected and used from the dispersed phases described for the raw material composition. In this case, the dispersed phase of the sealing liquid medium is selected so that at least one type is the same as the dispersed phase of the raw material composition.

Since the raw material composition and the sealing liquid medium include the same dispersed phase as each other, variation in solid content concentration can be further reduced for the dispersion composition after dispersion treatment, and variation in component uniformity of the solid content can be further reduced. From such a viewpoint, for example, the raw material composition and the sealing liquid medium may each include dispersed phases having the same chemical composition as each other, or may include dispersed phases that are the same simple substance or compound as each other. For example, the raw material composition and the sealing liquid medium may each include the same simple substance or compound among inorganic particles, organic particles, inorganic-organic composite particles, etc. Examples of inorganic particles include carbon materials, titanium oxide, etc., and examples of organic particles include phthalocyanine blue, isoindolinone-based pigments, etc.

In the case of the raw material composition and the sealing liquid medium mixing in the sealing mechanism, having the same dispersed phase as each other can reduce variation in dispersibility of the dispersed phase in the mixed liquid of the raw material composition and the sealing liquid medium. From such a viewpoint, for example, the raw material composition and the sealing liquid medium may each include dispersed phases having the same particle shape as each other. In the disclosure, having the same particle shape may mean that at least one of physical property values such as particle appearance observation, average particle diameter, particle size distribution, and specific surface area is within a predetermined range. For example, under the same measurement conditions, the particle diameter D50 at volume-based cumulative 50% of the particle size distribution measured by a dynamic light scattering method of the sealing liquid medium preferably falls within plus or minus 20% of the particle diameter D50 at volume-based cumulative 50% of the particle size distribution measured by a dynamic light scattering method of the raw material composition.

In addition, the raw material composition and the sealing liquid medium may each include dispersed phases that are the same allotrope as each other. Examples of allotropes of carbon materials include graphite, fullerene, carbon nanotube, graphene, etc. These examples of carbon materials can be treated as the same material as dispersed phases, but furthermore, it is preferable that the raw material composition and the sealing liquid medium each include the same allotrope, for example, each including carbon nanotube as the dispersed phase. This can further reduce variation in solid content concentration in the dispersion composition after dispersion treatment, and further reduce variation in component uniformity of the solid content.

In the case of using carbon nanotube as the dispersed phase, either single-walled carbon nanotube or multi-walled carbon nanotube may be used. In the case of using carbon nanotube, at least one of single-walled carbon nanotube and multi-walled carbon nanotube may be included as the dispersed phase in the raw material composition and the sealing liquid medium, respectively, regardless of the type. From the viewpoint of maintaining component uniformity of the solid content in the dispersion composition and suppressing generation of aggregates in the dispersion treatment, it is preferable that the raw material composition and the sealing liquid medium each include single-walled carbon nanotube as the dispersed phase, or include multi-walled carbon nanotube.

From the above viewpoint, the sealing liquid medium may include a single component dispersion medium, or may include two or more types of dispersion media. In the sealing liquid medium, the type of dispersion medium is not particularly limited, and one type or two or more types can be selected and used from the dispersion media described for the raw material composition. In this case, the dispersion medium of the sealing liquid medium is selected so that at least one type is the same as the dispersion medium of the raw material composition. For example, the raw material composition and the sealing liquid medium may each include dispersion media having the same chemical composition as each other, or may include dispersion media that are the same compound as each other. For example, the raw material composition and the sealing liquid medium may each include the same compound among N-methyl-2-pyrrolidone, water, propylene glycol monomethyl acetate, etc.

The content of the dispersed phase relative to the total amount of the sealing liquid medium varies depending on the specific gravity of the dispersed phase, but is preferably 0.1% by mass to 80% by mass, more preferably 0.5% by mass to 60% by mass, and even more preferably 0.7% by mass to 50% by mass. The sealing liquid medium preferably has a solid content amount of 0.5% by mass to 80% by mass, more preferably 0.7% by mass to 60% by mass, and even more preferably 1% by mass to 50% by mass.

Moreover, since the content of the dispersed phase in the sealing liquid medium relative to the total amount of the sealing liquid medium is within a variation range of 80% by mass to 120% by mass relative to the content of the dispersed phase in the raw material composition, it becomes possible to more appropriately maintain the solid content amount also in the obtained dispersion composition. Furthermore, since the solid content amount of the sealing liquid medium is within a variation range of 80% by mass to 120% by mass relative to the solid content amount of the raw material composition, it becomes possible to more appropriately maintain the solid content amount also in the obtained dispersion composition.

The sealing liquid medium may further include a dispersant to obtain dispersion stability of the dispersed phase. Both resin-type dispersants and surfactants can be used as the dispersant, but a suitable type of dispersant can be used in a suitable blending amount according to the characteristics required for dispersion of the dispersed phase. As the dispersant, at least one type can be selected and used from the dispersants mentioned for the raw material composition described above. It is preferable that the raw material composition and the sealing liquid medium each include the same dispersant as each other. This can further suppress deterioration of dispersibility of the dispersed phase in the case of the raw material composition and the sealing liquid medium contacting or mixing in the sealing mechanism. Moreover, since the mass ratio of the dispersant to the dispersed phase in the sealing liquid medium is within a variation range of 80% by mass to 120% by mass relative to the mass ratio in the raw material composition, the mass ratio of the dispersant to the dispersed phase is maintained also in the obtained dispersion composition, thereby further suppressing deterioration of dispersibility.

The sealing liquid medium may include optional components such as resin emulsion, surfactant, binder resin, wetting agent, wetting penetrant, and leveling agent as required. It is preferable that the raw material composition and the sealing liquid medium each include the same optional components as each other. This makes it possible to further suppress deterioration of dispersibility of the dispersed phase in the case of the raw material composition and the sealing liquid medium contacting or mixing in the sealing mechanism.

The sealing liquid medium preferably has a particle diameter D50 of 5 μm or less at volume-based cumulative 50% of the particle size distribution measured by a dynamic light scattering method. Hereinafter, this particle diameter D50 is also simply referred to as D50. An excessive D50 of the sealing liquid medium may cause friction with the inner peripheral surface of the cylinder 21 or the outer peripheral surface of the plunger 10 in the sealing mechanism, which may promote deterioration of these members. Moreover, in the state where the sealing liquid medium is held in the chamber 44 in the sealing mechanism, in the case of coarse particles being included, the possibility of causing clogging in the gap between members cannot be eliminated, which may promote deterioration of the members. From such a viewpoint, the D50 of the sealing liquid medium may be 5 μm or less, 3 μm or less, 1 μm or less, or 0.5 μm or less. The D50 of the sealing liquid medium may be 0.1 μm or more, 0.2 μm or more, or 0.3 μm or more from the viewpoint of suppressing aggregation of fine particles. For example, the D50 of the sealing liquid medium may be 0.1 μm to 5 μm, 0.1 μm to 3 μm, 0.1 μm to 1 μm, or 0.1 μm to 0.5 μm. From the viewpoint of further suppressing deterioration of the members of the sealing mechanism, the D50 of the sealing liquid medium is more preferably 0 μm to 5 μm, 0.1 μm to 3 μm, or 0.1 μm to 2 μm.

Moreover, the D50 of the sealing liquid medium preferably satisfies the above-mentioned numerical range in the case of the sealing liquid medium including carbon nanotubes. Carbon nanotube is a relatively hard dispersed phase, but in the case of satisfying the above-mentioned numerical range, deterioration of the members of the sealing mechanism can be more reliably suppressed.

In the disclosure, the particle size distribution of the dispersed phase in the dispersion medium is measured using a dynamic light scattering method unless otherwise specified. More specifically, the particle size distribution can be measured according to the method described in the examples.

The sealing liquid medium preferably has a viscosity of 20000 mPa·s or less at 25° C. In the case of the viscosity of the sealing liquid medium becoming excessive, the friction force between the cylinder 21 and the plunger 10 in the sealing mechanism increases, and the driving load of these increases, may promote deterioration of the members. Moreover, in the state where a high-viscosity sealing liquid medium is held in the chamber 44 in the sealing mechanism, the possibility of causing clogging in the gap between the members cannot be eliminated, which may promote deterioration of the members. From such a viewpoint, the viscosity of the sealing liquid medium may be 20000 mPa·s or less, 15000 mPa·s or less, 10000 mPa·s or less, 8000 mPa·s or less, or 5000 mPa·s or less. The lower limit value of the viscosity is not particularly limited, but from the viewpoint of ensuring fluidity of the sealing liquid medium, the viscosity of the sealing liquid medium may be 1 mPa·s or more, 10 mPa·s or more, 30 mPa·s or more, or 100 mPa·s or more. For example, the viscosity of the sealing liquid medium may be 10 mPa·s to 20000 mPa·s, 10 mPa·s to 15000 mPa·s, 30 mPa·s to 10000 mPa·s, 30 mPa·s to 8000 mPa·s, or 100 mPa·s to 5000 mPa·s. From the viewpoint of suppressing deterioration of the members of the sealing mechanism, the viscosity of the sealing liquid medium is more preferably 10 mPa·s to 10000 mPa·s, 10 mPa·s to 8000 mPa·s, or 10 mPa·s to 5000 mPa·s.

Moreover, the viscosity of the sealing liquid medium preferably satisfies the above-mentioned numerical range in the case of the sealing liquid medium including carbon nanotubes. Carbon nanotube is a relatively thickening dispersed phase, but in the case of satisfying the above-mentioned numerical range, deterioration of the members of the sealing mechanism can be more reliably suppressed.

In the disclosure, unless otherwise specified, the viscosity of the composition including a dispersed phase and a dispersion medium is a viscosity measured at 25° C. using a B-type viscometer at 60 rpm. More specifically, the viscosity can be measured according to the method described in the examples.

Further, the life of the sealing mechanism can be determined by performing 100 hours of operation using a dispersion apparatus with the combination of the raw material composition and the sealing liquid medium described in the examples mentioned later, and the leakage rate (%) can be calculated by measuring the leakage amount of the raw material composition from the sealing mechanism and the supply amount of the raw material composition represented by the following formula.

$$Leakage rate ( \% ) = ( Leakage amount ( L ) / Supply amount of raw material composition ( L ) ) \times 100$$

In the above formula, the leakage amount of the raw material composition from the sealing mechanism is the amount of the raw material composition that has leaked from the sealing mechanism during 100 hours of operation, and the supply amount of the raw material composition is the total amount discharged from the dispersion apparatus during 100 hours of operation.

From the viewpoint of production efficiency of the dispersion composition using a dispersion apparatus, it is preferable that the sealing mechanism of the dispersion apparatus has a low replacement frequency. In the case of a mechanism that seals the dispersion apparatus using a sealing liquid medium, it is not necessary to periodically replace gland packing, and the leakage rate can be controlled by pressure, thereby improving production efficiency.

The leakage rate represented by the above formula is preferably 0.2% or less, and more preferably 0.1% or less. In the case of the leakage rate being 0.21% or more, as the operation time increases, the leakage amount of the raw material composition from the sealing mechanism tends to increase, and the yield of the dispersion composition tends to decrease. By controlling the sealing pressure of the sealing liquid medium, the particle diameter D50 at volume-based cumulative 50% of the particle size distribution measured by a dynamic light scattering method, viscosity, and the like, it is assumed that the leakage rate represented by the above formula approaches 0% in the case where the sealing performance of the dispersion apparatus is more ensured.

### <Raw Material Composition Including Carbon Nanotube>

The dispersion apparatus according to an embodiment is suitable for applications that disperse while maintaining the shape of particles because the dispersion apparatus can disperse through high pressure treatment without applying mechanical impact to the particles. Furthermore, the dispersion apparatus is suitable for applications that enhance dispersibility by defibrating agglomerates like fibrous particles. For example, the dispersion apparatus can be suitably used in a method for producing a carbon nanotube dispersion liquid. Hereinafter, carbon nanotube is also referred to as CNT. In the raw material composition including carbon nanotubes, the dispersion medium described above can be used as the dispersion medium. In the raw material composition including carbon nanotubes, the dispersion medium may be either a non-aqueous dispersion medium or an aqueous dispersion medium, but preferably includes an aprotic solvent, a non-polar solvent, or a combination thereof, more preferably includes an aprotic solvent, and even more preferably includes an aprotic polar solvent. The aprotic polar solvent can better prevent aggregation of carbon nanotubes and has excellent solubility of resin-type dispersants suitable for carbon nanotube dispersion. Among these, it is preferable to include an amide-based solvent, and specifically, it is more preferable to include at least one selected from the group consisting of N-methyl-2-pyrrolidone, N-ethyl-2-pyrrolidone, and 1-n-octyl-2-pyrrolidone.

The carbon nanotube in the state before dispersion, to be used in the raw material composition, preferably has the following characteristics. CNT has a shape of planar graphite rolled into a cylindrical form, and examples include single-walled CNT, multi-walled CNT, etc., and these may be mixed. Single-walled CNT has a structure in which a single layer of graphite is rolled. Multi-walled CNT has a structure in which two, three, or more layers of graphite are rolled. In addition, the sidewall of CNT may not have a graphite structure. For example, CNT having a sidewall with an amorphous structure is also CNT in the disclosure.

The shape of CNT is not limited. Such shapes include various shapes including needle-like, cylindrical tube-like, fishbone-like (fishbone or cup-stacked type), trump-like (platelet), and coil-like. Among these, the shape of CNT is preferably needle-like or cylindrical tube-like. CNT may have a single shape or a combination of two or more shapes.

Examples of the form of CNT include graphite whisker, filamentous carbon, graphite fiber, ultrafine carbon tube, carbon tube, carbon fibril, carbon microtube, and carbon nanofiber. The carbon nanotube may have a single form of these or a form combining two or more types.

The average outer diameter of CNT is preferably 1 nm or more, and more preferably 4 nm or more. Further, the average outer diameter is preferably 30 nm or less, more preferably 20 nm or less, and even more preferably 15 nm or less. The average outer diameter of CNT can be calculated by first observing and imaging CNT with a transmission electron microscope, selecting arbitrary 300 CNTs in the observation photograph, measuring the outer diameter of each, and averaging the outer diameters.

The average fiber length of CNT is preferably 0.5 μm or more, more preferably 0.8 μm or more, and even more preferably 1.0 μm or more. Further, the average fiber length is preferably 1000 μm or less, more preferably 100 μm or less, and even more preferably 10 μm or less. The average fiber length of CNT can be calculated by first observing and imaging CNT with a scanning electron microscope, selecting arbitrary 300 CNTs in the observation photograph, measuring the fiber length of each, and averaging the fiber lengths.

The aspect ratio is the value obtained by dividing the fiber length of CNT by the outer diameter. A representative aspect ratio can be obtained using the values of average fiber length and average outer diameter. The higher the aspect ratio of the conductive material, the higher the conductivity that can be obtained in the case of forming an electrode. The aspect ratio of CNT is preferably 30 or more, more preferably 50 or more, and even more preferably 80 or more. In addition, the aspect ratio is preferably 1,000,000 or less, more preferably 100,000 or less, and even more preferably 10,000 or less.

The specific surface area of CNT is preferably 100 m²/g or more, more preferably 150 m²/g or more, and even more preferably 200 m²/g or more. In addition, the specific surface area is preferably 1200 m²/g or less, and more preferably 1000 m²/g or less. The specific surface area of CNT is calculated by a BET method using nitrogen adsorption measurement.

The carbon nanotube may be a carbon nanotube that has undergone surface treatment. The carbon nanotube may be a carbon nanotube derivative to which a functional group represented by a carboxy group has been added. A carbon nanotube encapsulating a substance represented by an organic compound, metal atom, or fullerene can also be used.

The raw material composition including carbon nanotubes may include a dispersant, and the dispersants described above can be used as the dispersant. In order to further enhance the dispersion stability of carbon nanotubes in the dispersion medium, it is preferable to use a resin-type dispersant. Methylcellulose, ethylcellulose, polyvinyl alcohol, polyvinyl butyral, polyvinyl pyrrolidone, homopolymers of polyacrylonitrile, copolymers of polyacrylonitrile, and hydrogenated acrylonitrile butadiene rubber are particularly preferable. The raw material composition including carbon nanotubes may further include optional components such as the binder resin described above.

The content of carbon nanotube is preferably 0.1% by mass to 20% by mass, more preferably 0.5% by mass to 15% by mass, and even more preferably 0.7% by mass to 10% by mass, relative to the total amount of the raw material composition. The dispersant is preferably 5.0% by mass to 300 parts by mass relative to 100 parts by mass of carbon nanotube. The raw material composition including carbon nanotubes preferably has a solid content amount of 0.5% by mass to 50% by mass, more preferably 0.7% by mass to 30% by mass, and even more preferably 1% by mass to 20% by mass.

### <Sealing Liquid Medium Including Carbon Nanotube>

In the case of using the raw material composition including carbon nanotubes, the sealing liquid medium preferably includes carbon nanotubes as the dispersed phase. The details of CNT are as described above. Preferably, in the case of using the raw material composition including carbon nanotubes, the sealing liquid medium includes carbon nanotubes as the dispersed phase and includes an aprotic solvent, a non-polar solvent, or a combination thereof as the dispersion medium.

Relative to the total amount of the sealing liquid medium, the content of carbon nanotube is preferably 0.1% by mass to 80% by mass, more preferably 0.5% by mass to 60% by mass, and even more preferably 0.7% by mass to 50% by mass. The dispersant is preferably 5.0 parts by mass to 300 parts by mass relative to 100 parts by mass of carbon nanotube. The sealing liquid medium preferably has a solid content amount of 0.5% by mass to 80% by mass, more preferably 0.7% by mass to 60% by mass, and even more preferably 1% by mass to 50% by mass.

### EXAMPLES

The present invention will be described more specifically below with reference to examples. The present invention is not limited to the following examples as long as it does not exceed the gist of the present invention. Unless otherwise specified, “parts” represents “parts by mass” and “%” represents “% by mass.”

### (Raw Material Composition)

The formulation of the raw material composition is as shown in Table 1. Each component was mixed according to the formulation shown in the table to obtain the raw material composition. The details of the components shown in the table are as follows.

Multi-walled CNT: “K-Nanos 100P” (trade name), manufactured by Kumho Petrochemical.

Single-walled CNT: “TNSR” (trade name), manufactured by Timesnano.

Copper phthalocyanine: “FASTOGEN EP-210” (trade name), manufactured by DIC.

Zetpol2000L (trade name): manufactured by Zeon Corporation.

APP-84 (trade name): carboxymethyl cellulose, manufactured by Nippon Paper Industries, “Sunrose AAPP-84” (trade name), weight average molecular weight 17600.

BYK-P104 (trade name): manufactured by BYK.

PGMAc shown in the table is propylene glycol monomethyl acetate. The binder resin solution shown in the table is the same as the binder resin solution produced with the CuPc dispersion liquid of the sealing liquid medium described later.

### (Sealing Liquid Medium)

The formulation of the sealing liquid medium is described below. The same components that are common with the above-described sealing liquid medium are used in the following formulation.

### Formulation of CNT Dispersion Liquid (1);

Multi-walled CNT: 3% by mass

N-methyl-2-pyrrolidone: 96% by mass

Dispersant “Zetpol2000L” (trade name): 1% by mass

Dispersion time: 20 hr

### Formulation of CNT Dispersion Liquid (2);

Multi-walled CNT: 3% by mass

N-methyl-2-pyrrolidone: 96% by mass

Dispersant “Zetpol2000L” (trade name): 1% by mass

Dispersion time: 5 hr

### Formulation of CNT Dispersion Liquid (3);

Multi-walled CNT: 6% by mass

N-methyl-2-pyrrolidone: 93% by mass

Dispersant “Zetpol2000L” (trade name): 1% by mass

Dispersion time: 20 hr

### Formulation of CNT Dispersion Liquid (4);

Single-walled CNT: 1% by mass

N-methyl-2-pyrrolidone: 98% by mass

Dispersant “Zetpol2000L” (trade name): 2% by mass

Dispersion time: 20 hr

### Formulation of CNT Dispersion Liquid (5);

Multi-walled CNT: 2% by mass

Ion-exchanged water: 97% by mass

Dispersant “APP-84 (trade name)”: 1% by mass

Dispersion time: 20 hr

### Formulation of CuPc Dispersion Liquid;

Copper phthalocyanine (“FASTOGEN EP-210” (trade name), manufactured by DIC): 10% by mass

Resin-type dispersant solution: 7.5% by mass

Binder resin solution: 35% by mass

PGMAc: 47.5% by mass

Dispersion time: 20 hr

The method for producing the CNT dispersion liquid in the sealing liquid medium is as follows.

Each component was mixed according to the above formulation, and a CNT dispersion liquid was obtained using the following dispersion apparatus.

A valve-type high pressure homogenizer “HC3-5” (trade name) manufactured by Sanmaru Machinery Co., Ltd. was used as the dispersion apparatus. The dispersion conditions were as follows.

### <Dispersion Conditions>

Treatment pressure: 100 MPa

Type of homogenizing part: flat valve

Flow rate of raw material composition: 2000 L/H

The method for producing the CuPc dispersion liquid in the sealing liquid medium is as follows.

Each component was mixed according to the above formulation, and a CuPc dispersion liquid was obtained using the dispersion apparatus in the same procedure as the CNT dispersion liquid in the sealing liquid medium described above.

### (Resin-Type Dispersant Solution)

The method for producing the resin-type dispersant solution in the formulation of the CuPc dispersion liquid is as follows.

PGMAc was added to BYK-P104 (manufactured by BYK-Chemie Japan: 50% non-volatile content) to adjust the non-volatile content to 40%, thereby obtaining a resin-type dispersant solution.

### (Binder Resin Solution)

The method for producing the binder resin solution in the formulation of the CuPc dispersion liquid is as follows.

A reaction vessel with a thermometer, a cooling tube, a nitrogen gas introduction tube, and a stirring device attached to a separable 4-neck flask was charged with 70.0 parts of cyclohexanone. The temperature was raised to 80° C., and after nitrogen substitution for the inside of the reaction vessel, a mixture of 13.3 parts of n-butyl methacrylate, 4.6 parts of 2-hydroxyethyl methacrylate, 4.3 parts of methacrylic acid, 7.4 parts of paracumylphenol ethylene oxide modified acrylate (trade name “Aronix M110” manufactured by Toagosei Co., Ltd.), and 0.4 parts of 2,2′-azobisisobutyronitrile was dropped from a dropping funnel over 2 hours. After completion of the dropping, the reaction was continued for an additional 3 hours to obtain a solution of acrylic resin having a weight average molecular weight (Mw) of 26,000. After cooling to room temperature, approximately 2 g of the resin solution was sampled, and heated and dried at 180° C. for 20 minutes to measure the non-volatile content, and propylene glycol monoethyl ether acetate (PGMAc) was added to the previously synthesized resin solution so that the non-volatile content became 20% by mass, to obtain a binder resin solution.

### (Dispersion Treatment)

A dispersion apparatus including a supply mechanism equivalent to the high pressure pump 20 shown in FIG. 2 and a dispersion mechanism using a homogenizing valve was used for the dispersion treatment of the raw material composition. In this dispersion apparatus, the raw material composition was supplied from the supply mechanism to a plunger, and the raw material composition was supplied from the plunger to the dispersion mechanism. In the plunger, the outer peripheral surface of the plunger was sealed by a sealing liquid medium. Dispersion treatment was performed using the raw material composition and the sealing liquid medium in the combinations shown in Table 1. The dispersion conditions were as follows.

### <Dispersion Conditions>

Treatment pressure: 100 MPa

Type of homogenizing part: flat valve

Flow rate of raw material composition: 2000 L/H

In Comparative Example 1, N-methyl-2-pyrrolidone was used as the sealing liquid medium. Other conditions were the same as Example 1.

In Comparative Example 2, gland packing was used as the sealing mechanism. Specifically, a valve-type high pressure homogenizer “HC3-5” (trade name) manufactured by Sanmaru Machinery Co., Ltd. was used as the dispersion apparatus. The dispersion conditions were as follows. Other conditions were the same as Example 1.

### <Dispersion Conditions>

Treatment pressure: 100 MPa

Type of homogenizing part: flat valve

Flow rate of raw material composition: 2000 L/H

Each evaluation is described below. The evaluation results are shown in Table 1.

D50 of the sealing liquid medium was measured by the same procedure as for the particle size distribution of the dispersion composition after dispersion treatment described later. The viscosity of the sealing liquid medium was measured using a B-type viscometer (“BL” manufactured by Toki Sangyo Co., Ltd.) at a rotor rotation speed of 60 rpm after the carbon nanotube dispersion liquid was left still in a constant temperature bath at 25° C. for 1 hour or more. The types of rotors used for measurement were No. 1 in the case of viscosity values less than 100 mPa·s, No. 2 in the case of 100 mPa·s or more and less than 500 mPa·s, No. 3 in the case of 500 mPa·s or more and less than 2,000 mPa·s, and No. 4 in the case of 2,000 mPa·s or more and less than 10,000 mPa·s, respectively.

### (Life of Sealing Mechanism)

The life of the sealing mechanism was evaluated by the following procedure. That is, operation was performed for 100 hours with use of the dispersion apparatus using the combinations of raw material composition and sealing liquid medium shown in Table 1. During the 100-hour operation time, the leakage amount of the raw material composition from the sealing mechanism and the supply amount of the raw material composition were measured, and the leakage rate (%) was calculated from the following formula.

$$Leakage rate ( \% ) = ( Leakage amount ( L ) / Supply amount of raw material composition ( L ) ) \times 100$$

In the above formula, the leakage amount is a value calculated by the following formula.

In the case of the sealing mechanism being the sealing liquid medium;
(1) Set the liquid in the sealing liquid medium tank before operation start to A liters.
(2) Set the liquid in the sealing liquid medium tank to B liters in the case of the total operation time reaching 100 hours.

$$Leakage amount ( L ) = B ( L ) - A ( L )$$

In the case of the sealing mechanism being gland packing;

In the case of the sealing mechanism being gland packing, the leakage rate was calculated from the leakage amount of the raw material composition from the sealing mechanism of the gland packing part, and the life of the sealing mechanism was evaluated.
(1) In the case of replacing the gland packing, the cooling liquid was also replaced. Set the cooling liquid amount at this time to X liters.
(2) Set the liquid in the cooling liquid circulation tank to Y liters in the case of the total operation time reaching 100 hours.

$$Leakage amount ( L ) = Y ( L ) - X ( L )$$

### <Judgment Criteria>

◯: Leakage rate 0.1% or less
Δ: Leakage rate exceeding 0.1% and 0.2% or less
x: Leakage rate 0.21% or more

### (Solid Content of Dispersion Composition)

1.5 g to 2.0 g of the dispersion composition after dispersion treatment was placed in an aluminum dish with a diameter of 7.5 cm and a height of 1 cm, and dried in an electric oven at 120° C.±5° C. for 1 hour. Thereafter, the mass of the solid content was measured, and the measured solid content was calculated. The difference between the measured solid content and the theoretical solid content was evaluated according to the following judgment criteria. The theoretical solid content was calculated from the mass of the solid content in the raw materials of the raw material composition.

### <Judgment Criteria>

◯: (Theoretical solid content)—(Measured solid content) is 0.5% or less
Δ: (Theoretical solid content)—(Measured solid content) exceeds 0.5% and is 1.0% or less
x: (Theoretical solid content)—(Measured solid content) is 1.1% or more

### (Particle Size Distribution of Dispersion Composition)

The particle size distribution of the dispersion composition after dispersion treatment measured by a dynamic light scattering method was evaluated according to the following procedure. After the dispersion composition was left still in a constant temperature bath at 25° C. for 1 hour or more, the dispersion composition was sufficiently stirred and diluted, and then the 50% particle diameter (D50) of the dispersion composition was measured on a volume basis using a particle size distribution meter (Nanotrac UPA, model UPA-EX, manufactured by MicrotracBEL Corp.). The dilution concentration of the CNT dispersion liquid was adjusted so that the loading index value became 0.85 to 1.25. The refractive index and density of the raw materials used for measurement were as follows. Refractive index of water: 1.333, refractive index of N-methyl-2-pyrrolidone: 1.47, refractive index of PGMAc: 1.402, density of multi-walled CNT and single-walled CNT: 1.80, density of copper phthalocyanine: 1.84

### <Judgment Criteria>

◯: D50≤0.5 μm
Δ: 0.5 μm<D50≤5 μm
x: D50>5 μm

TABLE 1-1

| | Raw material composition | | | | | | | |
|---|---|---|---|---|---|---|---|---|
| | Dispersed phase | | Dispersion medium | | Dispersant | | Binder resin | |
| | | Addition | | Addition | | Addition | | Addition |
| | Type | amount | Type | amount | Type | amount | Type | amount |
| Example 1 | Multi-walled | 3.0% | N-methyl- | 96.0% | Zetpol2000L | 1.0% | — | — |
| Example 2 | CNT | 3.0% | 2- | 96.0% | Zetpol2000L | 1.0% | — | — |
| Example 3 | | 3.0% | pyrrolidone | 96.0% | Zetpol2000L | 1.0% | — | — |
| Example 4 | Single-walled | 0.5% | | 98.5% | Zetpol2000L | 1.0% | — | — |
| | CNT | | | | | | | |
| Example 5 | Multi-walled | 3.0% | Ion- | 96.0% | APP-84 | 1.0% | — | — |
| | CNT | | exchanged | | | | | |
| | | | water | | | | | |
| Example 6 | Copper | 10% | PGMAc | 47.5% | BYK-P104 | 7.5% | Binder | 35.0% |
| | phthalocyanine | | | | | | resin | |
| | | | | | | | solution | |
| Comparative | Multi-walled | 3.0% | N-methyl- | 96.0% | Zetpol2000L | 1.0% | — | — |
| Example 1 | CNT | | 2- | | | | | |
| Comparative | | 3.0% | pyrrolidone | 96.0% | Zetpol2000L | 1.0% | — | — |
| Example 2 | | | | | | | | |

TABLE 1-2

| | | | | | Evaluation | | |
|---|---|---|---|---|---|---|---|
| | | | | | | | Particle size |
| | Sealing | Sealing liquid medium | | | Sealing | Solid | distribution |
| | mechanism | | | Viscosity | mechanism | content of | of dispersion |
| | Type | Type | D50 [μm] | [mPa · s] | life | dispersion | composition |
| Example 1 | Sealing | CNT | 0.15 | 3000 | ∘ | ∘ | ∘ |
| | liquid | dispersion | | | | | |
| | medium | liquid (1) | | | | | |
| Example 2 | | CNT | 0.6 | 1000 | Δ | ∘ | Δ |
| | | dispersion | | | | | |
| | | liquid (2) | | | | | |
| Example 3 | | CNT | 0.9 | 15000 | Δ | ∘ | ∘ |
| | | dispersion | | | | | |
| | | liquid (3) | | | | | |
| Example 4 | | CNT | 0.11 | 5000 | ∘ | ∘ | ∘ |
| | | dispersion | | | | | |
| | | liquid (4) | | | | | |
| Example 5 | | CNT | 0.18 | 2500 | ∘ | ∘ | ∘ |
| | | dispersion | | | | | |
| | | liquid (5) | | | | | |
| Example 6 | | CuPc | 0.1 | 30 | ∘ | ∘ | ∘ |
| | | dispersion | | | | | |
| | | liquid | | | | | |
| Comparative | Sealing | N-methyl-2- | — | — | ∘ | x | ∘ |
| Example 1 | liquid | pyrrolidone | | | | | |
| | medium | | | | | | |
| Comparative | Gland | — | — | — | x | ∘ | ∘ |
| Example 2 | packing | | | | | | |

From the above tables, it is understood that each example improves the life of the sealing mechanism compared to the sealing mechanism using gland packing, which is the conventional technology. In this case, it is understood that the solid content concentration is maintained in the obtained dispersion composition with at least one type of dispersion medium being the same and at least one type of dispersed phase being the same between the raw material composition and the sealing liquid medium.

Additionally, it is understood that there is a tendency for the life of the sealing mechanism to improve by making D50 of the sealing liquid medium smaller. In this case, it is also understood that D50 can be controlled in the obtained dispersion composition. Furthermore, it is understood that there is a tendency for the life of the sealing mechanism to improve by making the viscosity of the sealing liquid medium lower.

Although the present invention has been described with reference to the several embodiments above, the present invention is not limited to the several embodiments above. Various changes can be made to the configurations and details of the present invention within the scope of the present invention.

The disclosure of the present application is related to the subject matter described in Japanese Patent Application No. 2023-097975 filed on Jun. 14, 2023, the entire disclosure of which is incorporated herein by reference.

### DESCRIPTION OF REFERENCE NUMERALS

10 plunger, 20 high pressure pump, 21 cylinder, 22 supply port, 22a check valve, 23 discharge port, 23a check valve, 24 pump chamber, 25 outer sleeve, 30 dispersion part, 31 valve seat, 32 impact ring, 33 homo valve, 40 sealing mechanism, 41 sealing liquid medium supply pipe, 42 sealing liquid medium discharge pipe, 43 storage part, 44 chamber, 44a through opening, 45 pump, 50 raw material composition tank, 81 rod, 82 crankshaft

1. A method for producing a dispersion composition using a dispersion apparatus, which comprises a dispersion mechanism that pressurizes and disperses a raw material composition, a supply mechanism that comprises a plunger part and supplies the raw material composition to the dispersion mechanism, and a sealing mechanism that seals the plunger part using a sealing liquid medium,
wherein the raw material composition comprises a dispersed phase and a dispersion medium, and the sealing liquid medium comprises at least the same dispersed phase as the raw material composition and the same dispersion medium as the raw material composition.

2. The method for producing a dispersion composition according to claim 1, wherein the sealing liquid medium is pressurized using an independent pump and supplied to the sealing mechanism.

3. The method for producing a dispersion composition according to claim 1, wherein the sealing liquid medium has a particle diameter D50 of 5 μm or less at volume-based cumulative 50% of a particle size distribution measured by a dynamic light scattering method.

4. The method for producing a dispersion composition according to claim 1, wherein the sealing liquid medium has a viscosity of 10000 mPa s or less at 25° C.

5. The method for producing a dispersion composition according to claim 1, wherein the sealing liquid medium has a particle diameter D50 of 5 μm or less at volume-based cumulative 50% of a particle size distribution measured by a dynamic light scattering method, and the sealing liquid medium has a viscosity of 10000 mPa s or less at 25° C.

6. The method for producing a dispersion composition according to claim 1, wherein the plunger part comprises a cylinder and a plunger, a gap G is formed between an inner peripheral surface of the cylinder and an outer peripheral surface of the plunger, the raw material composition in the gap G is at positive pressure relative to the sealing liquid medium, an external pressure for pressurizing the sealing liquid medium is 50 bar to 5000 bar, and an internal pressure for pressurizing the raw material composition is 80 bar to 8000 bar.

7. The method for producing a dispersion composition according to claim 1, wherein the plunger part comprises a cylinder and a plunger, a gap G is formed between an inner peripheral surface of the cylinder and an outer peripheral surface of the plunger, and the sealing mechanism comprises supplying the sealing liquid medium into the cylinder to fill the gap G, discharging and recovering the sealing liquid medium from the gap G, and disposing the recovered sealing liquid medium or recirculating the recovered sealing liquid medium into the cylinder.

8. The method for producing a dispersion composition according to claim 1, wherein the plunger part comprises a cylinder and a plunger, a gap G is formed between an inner peripheral surface of the cylinder and an outer peripheral surface of the plunger, a chamber for holding the sealing liquid medium is formed on the inner peripheral surface of the cylinder, a pressure between the gap G and the chamber is released through a through hole, and the sealing mechanism comprises supplying the sealing liquid medium to the chamber, discharging and recovering the sealing liquid medium from the chamber, and disposing the recovered sealing liquid medium or recirculating the recovered sealing liquid medium to the chamber.
